(19) United States
(12) Patent Application Publication
(10) Pub. No.: US 2010/0074570 A1
(43) Pub. Date: Mar. 25, 2010

(54) OPTICAL CIRCUIT

(75) Inventor: Koji Terada, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/391,709

(22) Filed: Feb. 24, 2009

(30) Foreign Application Priority Data
Feb. 27, 2008 (JP) 2008-046339

(51) Int. Cl. G02F 1/01; G02B 6/12

(52) U.S. Cl. 385/1; 385/14; 385/3

(57) ABSTRACT

According to an aspect of an embodiment, an optical circuit comprising: at least two pairs of two input waveguides; a slab waveguide with one end coupled to two pairs or more of the two input waveguides; and four output waveguides coupled to another end of the slab waveguide; wherein a distance between two pairs of adjacent two input waveguides among two pairs or more of the two input waveguides is approximately four times as long as a distance between the two input waveguides.

### CROSS-REFERENCE TO RELATED APPLICATIONS

This application is based upon and claims the benefit of priority of the prior Japanese patent application no. 2008-046339, filed on Feb. 27, 2008, the entire contents of which are incorporated herein by reference.

### BACKGROUND

1. Field

The present disclosure relates to an optical circuit suitably used for optical communication. The present disclosure relates to an optical circuit suitably used particularly in a reception front end of differential phase shift keying modulated light.

2. Background

There has been developed an optical transmitter and receiver for differential phase shift keying system such as differential quadrature phase shift keying (DQPSK) to realize an ultra high-speed optical transmission system having a transmission speed of 40 Gbit/s or more (baud rate 20 Gbit/s). A DQPSK modulation system is a system in which any of four phase differences of the phase difference with an optical phase of one symbol before is provided to modulate two-bit information into one symbol.

When such phase modulated light is received, even if it is directly received by a photo diode, like intensity modulated light, a direct-current signal is merely obtained, so that optical phase information being a modulated component cannot be obtained from the input DQPSK modulated light. For this reason, a delay interferometer has been conventionally used to extract optical phase information in phase modulated light.

Specifically, the delay interferometer as an optical circuit at a reception front end is so formed as to output such an interference light that the intensity is varied according to how much the interference light is superposed on light as a reference. A change in intensity of output of the interference light is detected by a photo diode to obtain optical phase information as a change in intensity of light. Such a circuit unit for comparing the overlapping state of phases forming such a phase modulated light is sometimes called a “demodulator”.

The following Patent Documents 1 and 2 and Non-Patent Document 1 describe examples of optical circuits for providing the above-mentioned interference light. Patent Document 1 describes a delay interference optical circuit of the DPSK modulated light. There may be required two circuit configurations in parallel to interfere light so that the DQPSK modulated light is received. In Patent Document 2 and Non-Patent Document 1, the DQPSK modulated light can be received by one optical interference element.
Patent Document 1: Japanese Patent Laid-Open No. 2006-039037
Patent Document 2: Japanese Patent Laid-Open No. 2003-046446
Non-Patent Document 1: Christopher R. Doerr, et al., “Monolithic Demodulator for 40-Gb/s DQPSK Using a Star Coupler”, IEEE JOURNAL OF LIGHTWAVE TECHNOLOGY, VOL. 24, NO. 1, JANUARY 2006

### SUMMARY

According to an aspect of an embodiment, an optical circuit includes at least two pairs of two input waveguides; a slab waveguide, an end of which is coupled to two pairs or more of the two input waveguides; and four output waveguides coupled to another end of the slab waveguide. A distance between two pairs of adjacent two input waveguides among two pairs or more of the two input waveguides is approximately four times as long as a distance between the two input waveguides.

### BRIEF DESCRIPTION OF THE DRAWINGS

FIG. 1 is a block diagram illustrating an optical communication system to which a demodulator as an optical circuit in the first embodiment is applied;

FIG. 2 is an example of the DQPSK modulated light subjected to DQPSK modulation by each phase modulator;

FIG. 3 is a chart illustrating a function of the demodulator;

FIG. 4 is a chart illustrating the function of the demodulator;

FIG. 5 is a schematic diagram illustrating an optical circuit in the first embodiment;

FIG. 6 is a schematic diagram illustrating an interference waveguide unit in the first embodiment;

FIG. 7 is a schematic diagram illustrating an interference waveguide unit in the first embodiment;

FIGS. 8A to 8E are charts illustrating the electric field intensity distribution of interference waveforms according to phase shift quantity in the optical circuit of the first embodiment;

FIG. 9 is a chart illustrating the electric field intensity distribution of light imaged by interference as divided into a plurality of peaks;

FIG. 10 is a chart illustrating an output intensity distribution obtained by delay adjustment;

FIGS. 11A and 11B are charts illustrating the output intensity distribution according to phase shift quantity;

FIG. 12 is a chart illustrating an optical circuit as a comparison configuration example;

FIGS. 13A to 13D are charts illustrating the electric field intensity distribution of interference waveforms according to phase shift quantity in the optical circuit illustrated in FIG. 12;

FIGS. 14A to 14D are charts illustrating the comparison of operational advantages between the configurations of the first embodiment and FIG. 12;

FIG. 15 is a schematic diagram illustrating an optical circuit in the second embodiment;

FIG. 16 is a chart illustrating operational advantages of the second embodiment; and

FIG. 17 is a chart illustrating operational advantages of the second embodiment.

### DETAILED DESCRIPTION OF THE PREFERRED EMBODIMENTS

The present embodiment is described with reference to the drawings.

### [a] Description of the First Embodiment

[a1] Configuration

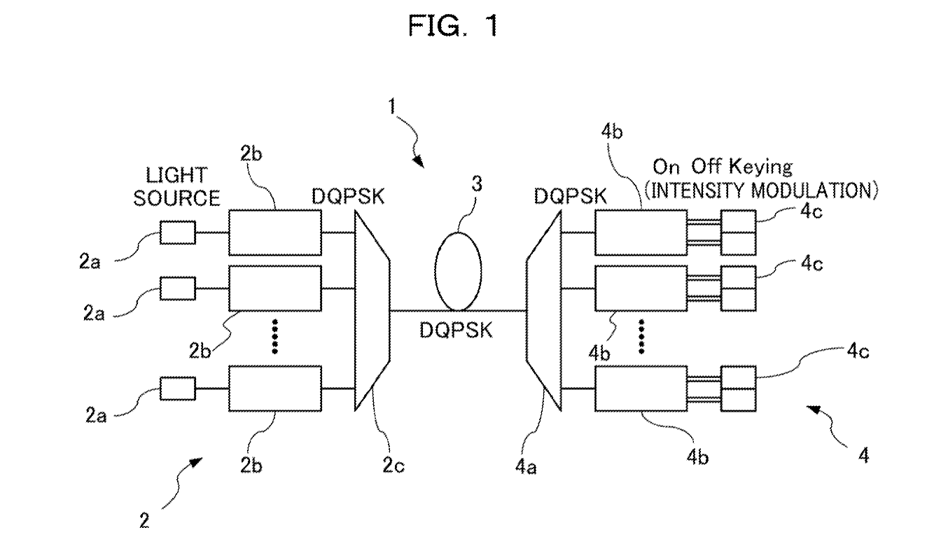

FIG. 1 is a block diagram illustrating an optical communication system to which a demodulator as an optical circuit in the first embodiment is applied. An optical communication system 1 described in FIG. 1 connects a transmission apparatus 2 to a reception apparatus 4 through an optical transmission line 3 and performs wavelength multiplex communication of a plurality of series of DQPSK modulated lights.

The transmission apparatus 2 is provided with a plurality of light sources 2a different in wavelength, a plurality of phase modulators 2b for performing the DQPSK modulation of a series of data corresponding to lights from the light sources 2a, and a wavelength multiplexer 2c for multiplexing the wavelengths of DQPSK modulated lights from the phase modulators 2b. The reception apparatus 4 is provided with a wavelength demultiplexer 4a for separating wavelengths of wavelength-multiplexed light from the transmission apparatus 2, a plurality of demodulators 4b for subjecting the series of DQPSK modulated lights separated by the wavelength demultiplexer 4a to delay and interfere the light, and a plurality of balanced receivers 4c for balanced-receiving the delayed and interfered light output from each of the demodulators 4b.

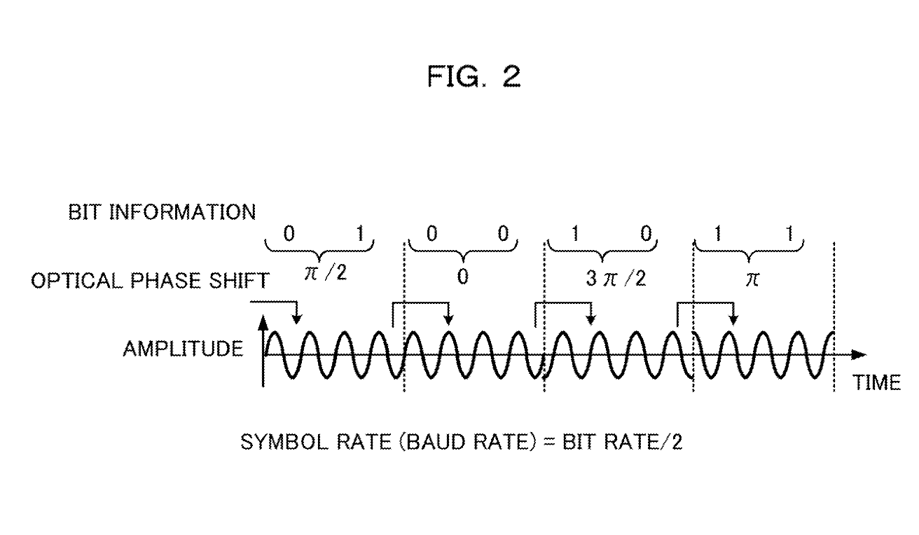

FIG. 2 is a chart describing an example of the DQPSK modulated light subjected to the DQPSK modulation by the phase modulators 2b. As illustrated in FIG. 2, in the DQPSK modulation, two-bit information according to a phase shift quantity (of the current symbol) with respect to an optical phase of one symbol before is modulated. For example, if phase shift quantities are π/2, 0, 3π/2, and π, bit information (0, 1), (0, 0), (1, 0), and (1, 1) are modulated respectively.

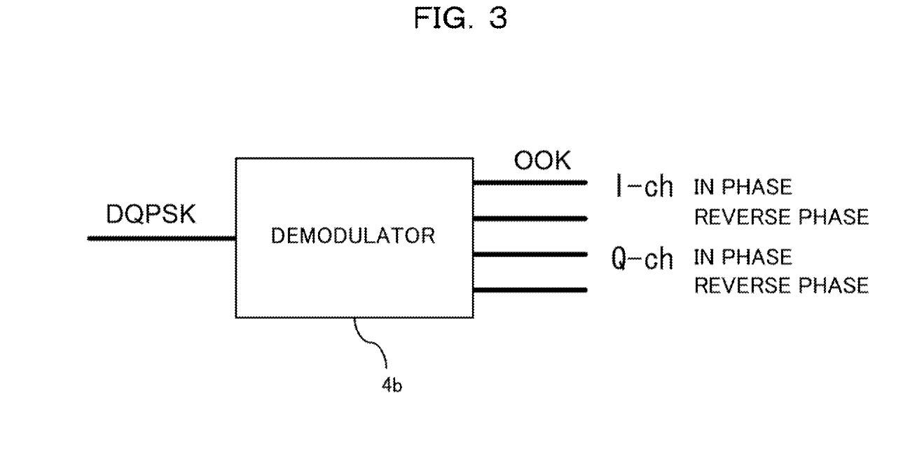

The demodulators 4b of the reception apparatus 4 subject the DQPSK modulated light input from the wavelength demultiplexer 4a to delay and interference, and output an intensity modulation light (On-Off keying: OOK) according to a phase shift quantity with respect to an optical phase of one symbol before, as described above. As illustrated in FIG. 3, the demodulator 4b outputs the in-phase and the reverse phase of a channel I and the in-phase and the reverse phase of a channel Q.

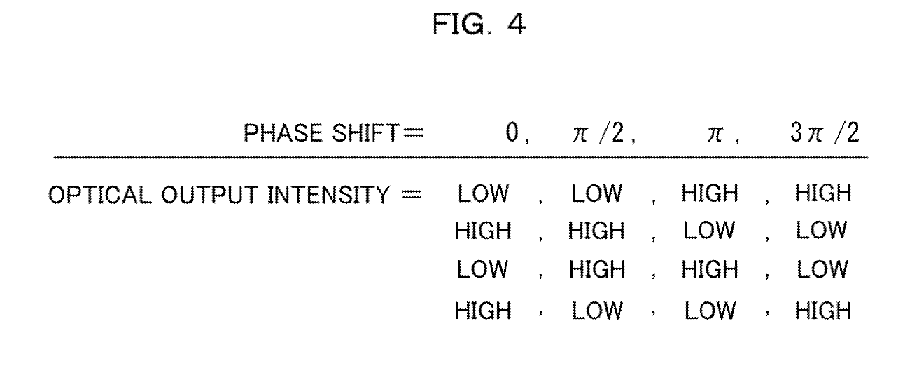

As illustrated in FIG. 4, the intensity patterns of four output signals from the demodulator 4b are associated with four kinds of phase shift quantities modulated to the DQPSK modulated light. In this case, if the outputs of the in-phase and the reverse phase of the channel I and the in-phase and the reverse phase of the channel Q are “low, high, low, high” respectively, a phase shift quantity can be rendered zero. Similarly, if the outputs of the in-phase and the reverse phase of the channel I and the in-phase and the reverse phase of the channel Q are “low, high, high, low,” “high, low, high, low,” and “high, low, low, high”, phase shift quantities can be rendered π/2, π, and 3π/2 respectively.

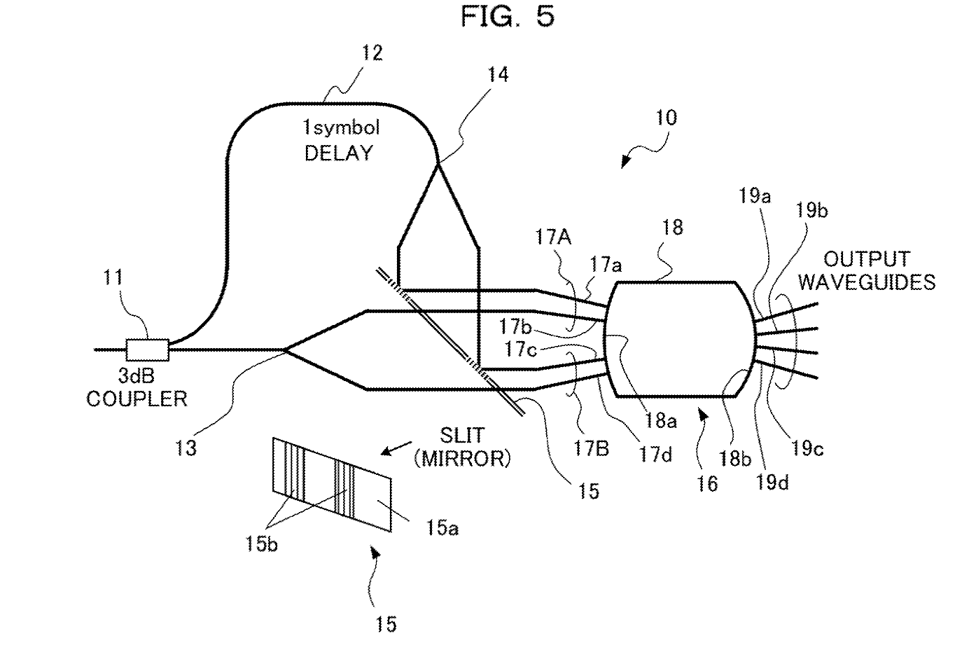

FIG. 5 is a schematic diagram describing an optical circuit 10 applied as the demodulator 4b of the reception apparatus 4 in the optical communication system 1 illustrated in FIG. 1. The optical circuit 10 described in FIG. 5 includes a 3 dB coupler 11, a delay waveguide 12, Y branch waveguides 13 and 14, a mirror member 15, and an interference waveguide unit 16.

The 3 dB coupler 11 is a first branch unit for branching the differential phase shift keying (DPSK) modulated light input from the wavelength demultiplexer 4a into two lights. One of the lights branched by the 3 db coupler 11 is led to the delay waveguide 12 and the other light is led to the Y branch waveguide 14. The delay waveguide 12 is a delay unit for delaying the one light branched by the 3 dB coupler 11 by “one symbol −λ/4” with respect to the other light. The light propagating through the delay waveguide 12 is led to the Y branch waveguide 14. Here, “λ” denotes a light wavelength.

The delay waveguide 12 generates the light delayed by one symbol as the light having a phase being a comparison reference of an optical phase with reference to an input light in the interference waveguide unit 16 at the rear stage. In the present embodiment, a delay distance shorter by λ/4 than one symbol distance is provided by a delay adjustment. As described below, the adjustment of the delay distance enables the intensity of lights from two outputs out of four outputs of the demodulators 4b to be comparatively larger and the intensity of lights from the other two outputs to be comparatively smaller. A similar effect can be realized by providing a delay distance shorter by λ/4 than one symbol distance by a delay adjustment.

The Y branch waveguide 13 is a second branch unit for further branching, into two lights, the other one of the lights branched by the 3 dB coupler 11. The differential phase-shift-keying light (not delayed) branched by the Y branch waveguide 13 is led to input waveguides 17b and 17d forming the interference waveguide unit 16 at the rear stage. The Y branch waveguide 14 is a third branch unit for further branching the light delayed by the delay waveguide 12 into two lights. The differential phase-shift-keying light (delayed) branched by the Y branch waveguide 14 into two lights is led to input waveguides 17a and 17c forming the interference waveguide unit 16 at the rear stage via the reflection of the mirror member 15.

As described below, the angle and distance of the input waveguides 17a to 17d forming the interference waveguide unit 16 are specified. The light branched by the Y branch waveguide 14 is reflected by the mirror member 15 to deflect the propagation direction, matching the direction in which the input waveguides 17a and 17c are formed. Thus, the light branched by the Y branch waveguide 14 is led to the input waveguides 17a and 17c with a low loss along with the light led from the Y branch waveguide 13 to the input waveguides 17b and 17d. The mirror member 15 is made of, for example, polyimide film 15a on which Au film 15b being optical reflection film is formed. The light branched by the Y branch waveguide 14 is reflected by the Au film 15b and deflected.

The input waveguides 17a and 17b among the input waveguides 17a to 17d form a waveguide pair 17A as a pair of input waveguides and the input waveguides 17c and 17d form a waveguide pair 17B as another pair of input waveguides. The waveguide pairs 17A and 17B introduce the input light phase-modulated and the input light delayed by “one symbol −λ/4” respectively.

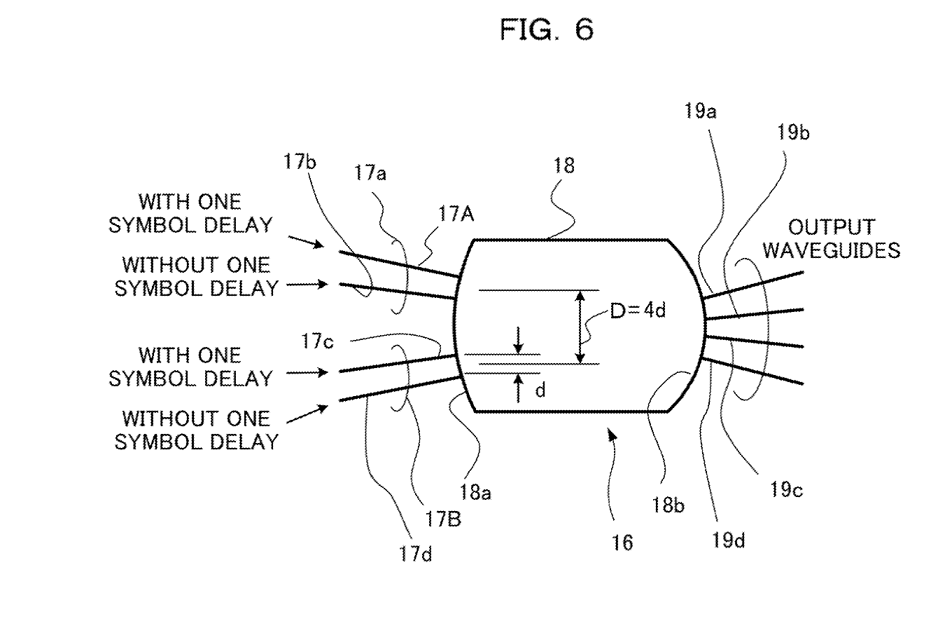

As described in FIG. 6, the input waveguide 17b introduces one differential phase-shift-keying light (not delayed) from the Y branch waveguide 13 and the input waveguide 17a introduces one delayed differential phase-shift-keying light propagating from the Y branch waveguide 14 via the mirror member 15. Similarly, the input waveguide 17d introduces the other differential phase-shift-keying light (not delayed) from the Y branch waveguide 13 and the input waveguide 17c introduces the other delayed differential phase-shift-keying light propagating from the Y branch waveguide 14 via the mirror member 15.

Thus, the optical circuit includes the 3 dB coupler 11, the delay waveguide 12, the Y branch waveguides 13 and 14, and the mirror member 15, and the configuration generates delayed light of the input phase-shifted light. There is formed a delay branch circuit for branching and outputting the light introduced to two pairs of the input waveguide pairs 17A and 17B into two lights: the phase-modulated light and the light of one symbol before.

The interference waveguide unit 16 generates interference between the lights from the Y branch waveguide 13 and the mirror member 15 to form the above delay branch circuit and outputs intensity modulation signals corresponding to data modulated by the differential shift keying. The interference waveguide unit 16 includes the input waveguides 17a to 17d forming the waveguide pairs 17A and 17B, a slab waveguide 18, and output waveguides 19a to 19d.

The slab waveguide 18 causes the input lights to interfere with each other through the input waveguides 17a to 17d. One end 18a of the slab waveguide 18 is coupled to the input waveguides 17a to 17d that form the two pairs of the waveguide pairs 17A and 17B, and the other end 18b is coupled to the four output waveguides 19a to 19d.

The output waveguides 19a to 19d are configured to output light, in which the lights introduced from the input waveguides 17a to 17d forming the two pairs of the waveguide pairs 17A and 17B are caused to interfere with each other in the slab waveguide 18, as intensity modulation light according to phase modulation. In this case, the output waveguides 19a to 19d can be made the in-phase output of the channel I, the reverse phase output of the channel Q, the reverse phase output of the channel I, and the in-phase output of the channel Q.

The balanced receivers 4c (refer to FIG. 1) balanced-receive the in-phase and the reverse phase output of the channel I from the output waveguides 19a and 19c to enable the in-phase and the reverse phase output thereof to be rendered an output I, and also balanced-receive the in-phase and the reverse phase output of the channel Q from the output waveguides 19d and 19b to enable the in-phase and the reverse phase output thereof to be rendered an output Q.

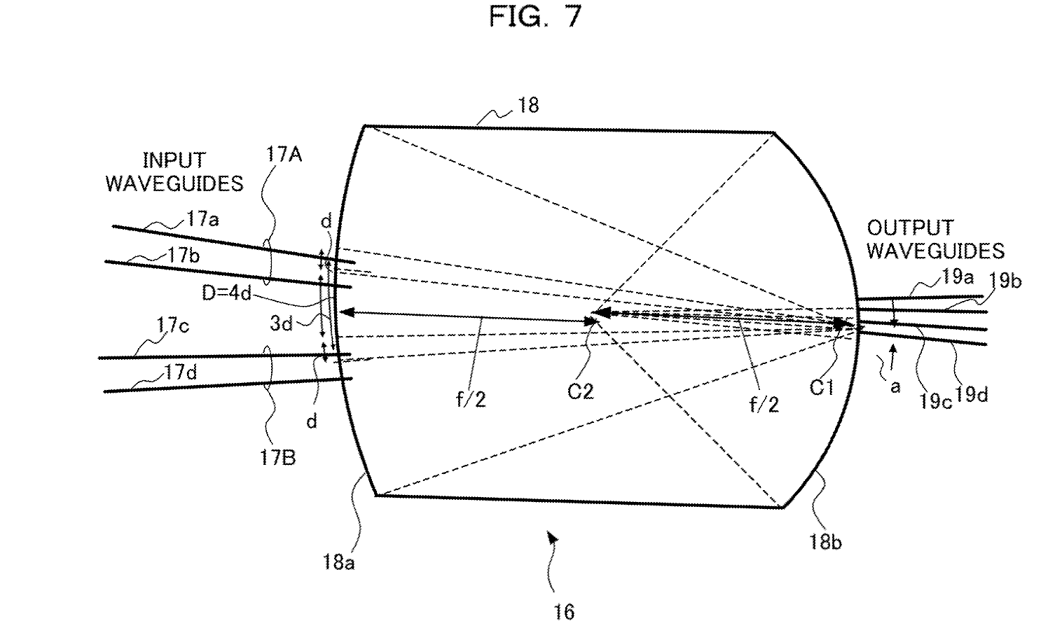

FIGS. 6 and 7 are schematic diagrams describing the configuration of the interference waveguide unit 16. As illustrated in FIG. 7, the contour of the end 18a of the slab waveguide 18 is substantially arced around a center point C1 of the end 18b. The contour of the end 18b is substantially arced around a center point C2 in the longitudinal direction of the slab waveguide 18. The input waveguides 17a to 17d are formed in the direction along lines extended from the middle line C1. The output waveguides 19a to 19d are formed in the direction along lines extended from the middle line C2.

The input waveguides 17a and 17b forming the waveguide pair 17A and the input waveguides 17c and 17d forming the waveguide pair 17B are coupled to the end 18a of the slab waveguide 18 with a substantially equal distance d therebetween. A distance D between the two waveguide pairs 17A and 17B is substantially four times (=4d) as great as the distance d between the input waveguides forming the waveguide pairs.

Since the distance D between the waveguide pairs 17A and 17B is set as described above, an electric field intensity distribution (optical power distribution) at an image plane can be formed into a higher-mode shape when lights introduced to the input waveguides 17a to 17d are caused to interfere with each other and are imaged at the end 18b of the slab waveguide 18 irrespective of a phase shift quantity with respect to a prior symbol in differential shift keying.

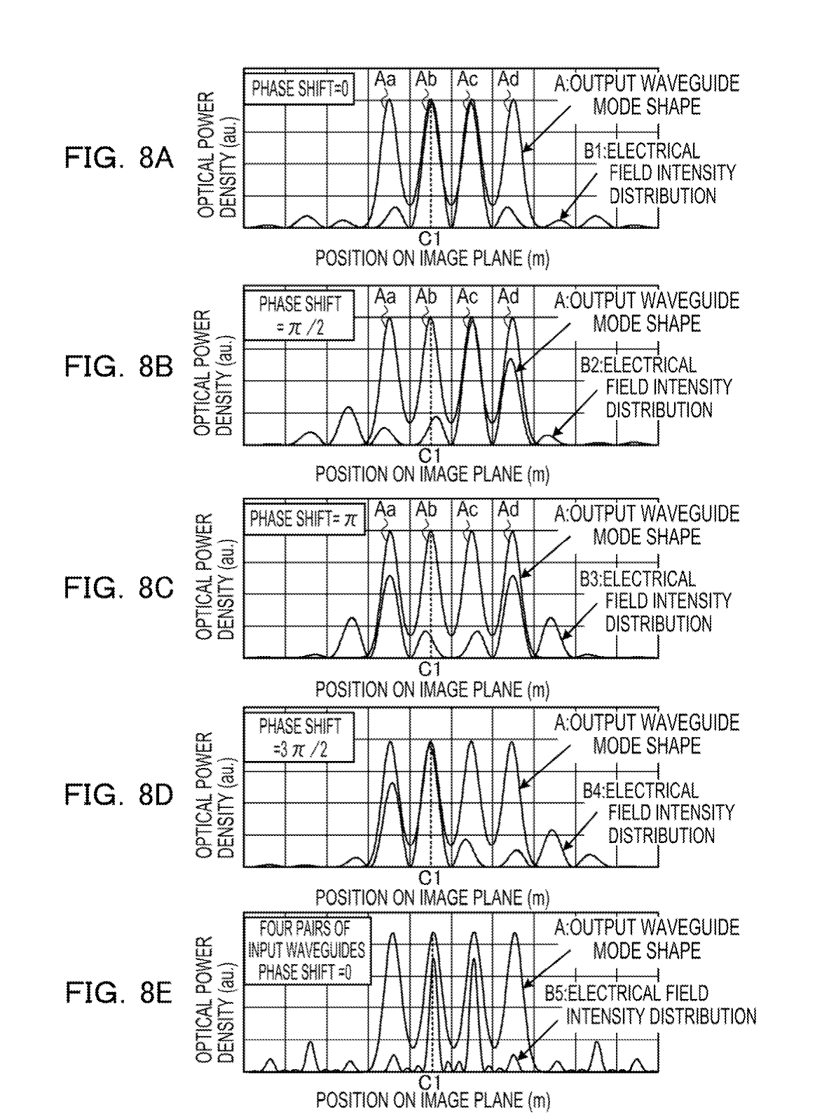

For example, as illustrated in FIGS. 8A to 8D, electric field intensity distributions act as B1 to B4 as a function of position (position of the end 18b) on the image plane of an interference waveform according to a phase shift quantity (0, π/2, π, and 3π/2). At this point, although each of the electric field intensity distributions B1 to B4 has four peaks at the center, the peak positions can be obtained in a substantially equal image plane positions independently of respective phase shift quantities. In FIGS. 8A to 8D, the center point C1 of the end 18b of the slab waveguide 18 corresponds to the peak position of the electric field intensity distribution B2.

As indicated by the output waveguide mode shapes A (Aa to Ad) of FIGS. 8A to 8D, if the output waveguides 19a to 19d are formed in four positions corresponding to the above described peaks of the electric field intensity distributions, the lights imaged in positions being peak positions are optically coupled to the corresponding output waveguides 19a to 19d, so that an efficiency of coupling interference light to the output waveguides 19a to 19d can be significantly improved as compared to a conventional art. In FIGS. 8A to 8D, reference characters Aa to Ad denote examples of mode shapes of lights which are coupled to the output waveguides 19a to 19d, respectively.

Although the above case has been described where the number of pairs of the input waveguides 17a and 17b is two, the number of pairs of the input waveguides may be two or more. The increase of the number of pairs decreases the width of each peak with the distance of the electric field intensity distributions B1 to B4 kept as is. FIG. 8E illustrates an electric field intensity distribution B5 and the output waveguide mode shape A in the case where the number of pairs of the input waveguides is four.

[a2] Electric Field Intensity Distribution of Light Imaged by Interference being Divided into a Plurality of Peaks

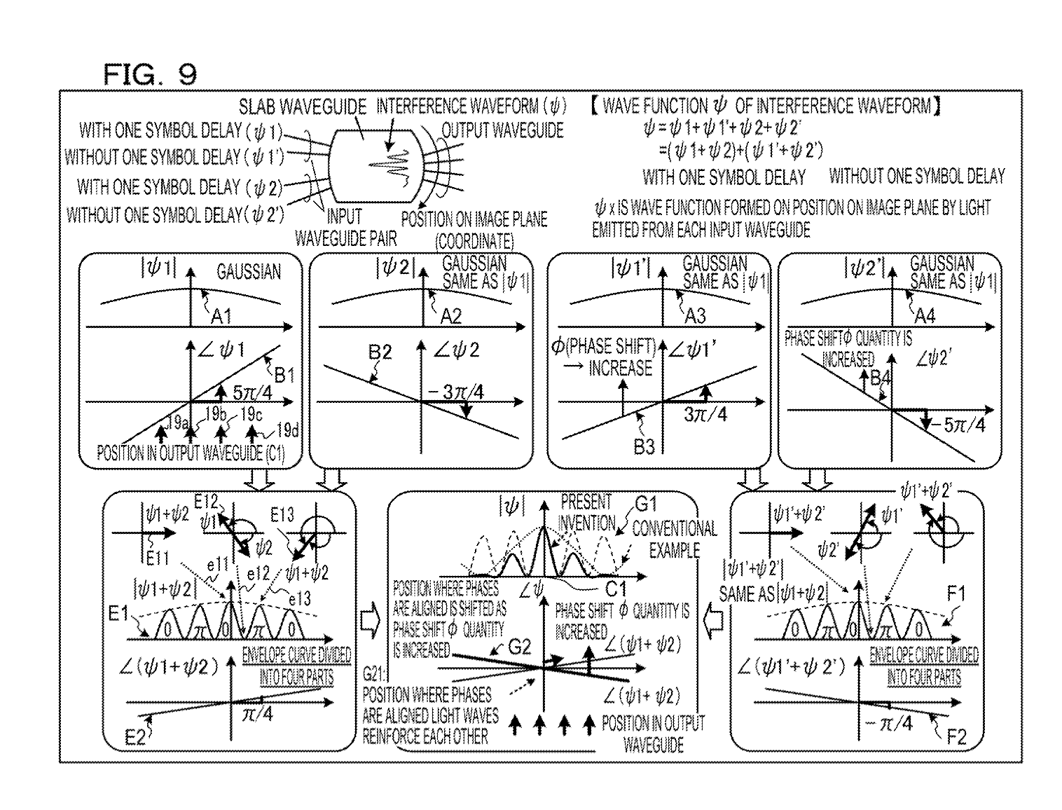

FIG. 9 is a chart describing the division of the electric field intensity distribution of light imaged by interference into a plurality of peaks by the configuration of the input waveguides 17a to 17d. Although FIG. 9 focuses particularly on the case where a phase shift quantity φ related to the differential phase shift keying between symbols is zero, even if the phase shift quantity φ is not zero, the division of the electric field intensity distribution into a plurality of peaks may be understood in FIG. 9. For simplicity of description, an adjustment factor for a delay quantity of −λ/4 in the delay waveguide 12 is omitted.

As illustrated in FIG. 9, if wave functions in which lights introduced from the input waveguides 17a to 17d form in positions on the image plane of the end 18b are taken as ψ1, ψ1′, ψ2, and ψ2′ respectively, the wave function ψ of an interference waveform in position on the image plane can be expressed as Equation (1). Here, x=1 at ψx represents a wave function derived from light from the optical waveguides 17a and 17b forming the waveguide pair 17A and x=2 at ψx represents a wave function derived from light from the optical waveguides 17c and 17d forming the waveguide pair 17B. A prime (′) is added to the wave function derived from light without a delay of one symbol.

$$\begin{matrix}ψ = ψ 1 + ψ {1}^{′} + ψ 2 + ψ {2}^{′} \\ = ( ψ 1 + ψ 2 ) + ( ψ {1}^{′} + ψ {2}^{′} )\end{matrix} \qquad ( 1 )$$

Here, the electric field intensity distributions in positions on the image plane in ψ1, ψ1′, ψ2, and ψ2′ (respective absolute values) form substantially the same Gaussian distribution with peaks at the center point C1 (refer to FIG. 7) at the end 18b as indicated by A1 to A4 of FIG. 9 when positions on the image plane are developed to abscissa coordinates. On the other hand, phase distributions in positions on the image plane in ψ1, ψ1′, ψ2, and ψ2′ have slope characteristics indicated by B1 to B4 because distances between the incident positions on the slab waveguide 18 and the end 18b are varied with positions on the image plane.

As indicated by B1, the phase distribution (∠ψ1) of ψ1 derived from light input from the input waveguide 17a has a slope which increases only by 5π/4 between the adjacent output waveguides in the direction from a position on the image plane where the output waveguide 19a is formed toward a position on the image plane where the output waveguide 19d is formed. As indicated by B4, the phase distribution (∠ψ2) of ψ2′ derived from light input from the input waveguide 17d has a slope opposite to the case of ψ1 and the phase quantity decreases by only 5π/4 between the adjacent output waveguides.

As indicated by B3, since the input waveguide 17b is formed inside the input waveguide 17a which is on the outside, the phase distribution (∠ψ1′) of ψ1′ derived from light input from the input waveguide 17b has a slope which is more gentle than ψ1 and increases by only 3π/4 between the adjacent output waveguides. As indicated by B2, the phase distribution (∠ψ2′) of ψ2 derived from light input from the input waveguide 17c has a slope which is more gentle than ψ2′ and decreases by 3π/4 between the adjacent output waveguides. Phases in the above phase displacements B1 to B4 are zero at center point C1 in positions on the image plane (refer to FIG. 7).

Vector addition is performed on a phase plane corresponding to positions on the image plane based on the Equation (1) of the above ψ to provide E1 in FIG. 9 as an electric field intensity distribution of ψ1+ψ2, and to provide E2 as a phase distribution (∠ψ1+ψ2). As indicated by A1 and A2, the electric field intensity distributions of ψ1+ψ2 being addition factors are substantially equal to each other. However, the interference between light of ψ1 and light of ψ2, which have different phase distributions, divides the envelope curve of the electric field intensity distribution of ψ1+ψ2 into an electric field intensity distribution with a plurality of peaks as indicated by E1. As indicated by E2, the phase quantity of the phase distribution (∠ψ1+ψ2) becomes zero in the center point C1 and increases (by π/4 between the adjacent output waveguides) toward corresponding positions from the output waveguide 19a to the output waveguide 19d.

For example, as indicated by E1, if a position on the image plane is in a position e11 corresponding to C1 in FIG. 7, both phases of ψ1 and ψ2 are zero. Light waves reinforce each other to produce a peak of optical intensity (refer to E11). An image-plane position e12 is a position where the phases of ψ1 and ψ2 are substantially shifted by π. Light waves weaken each other to substantially minimize optical intensity (refer to E12). An image-plane position e13 is a position where the phases of ψ1 and ψ2 are substantially aligned again with each other. Light waves reinforce each other to produce a peak of optical intensity (refer to E13).

The vector addition of ψ1′ and ψ2′ on the phase plane corresponding to a position on the image plane provides F1 in FIG. 9 for the electric field intensity distribution of ψ1′+ψ2′ and F2 for phase distribution. In this case also, the interference between light of ψ1′ and light of ψ2′ which are different in phase distribution from each other divides the envelope curve of the electric field intensity distribution of ψ1′+ψ2′ into an electric field intensity distribution with a plurality of peaks as indicated by F1 (refer to phase relations F11 to F13 in positions on the image plane f11 to f13). On the other hand, the phase distributions (∠ψ1′+ψ2′) of ψ1′+ψ2′ are opposite each other in a sloping direction; however, the displacement between the adjacent output waveguides is equal to (π/4). Phases in the above phase displacement E2 and F2 are zero at center point C1 in positions on the image plane (refer to FIG. 7).

Adding (ψ1+ψ2) to (ψ1′+ψ2′) in accordance with the above Equation (1) produces G1 in respect to the electric field intensity distribution of ψ and G2 in respect to phase distribution. In this case also, light waves reinforce each other to produce a peak of optical intensity (refer to G21) in a position C1 where the phases are substantially aligned with each other. If the phase shift quantity φ is greater than zero, a position where phases are aligned moves along G2 according to the phase shift quantity. For this reason, positions themselves on the image plane where an electric field intensity distribution reaches a peak are the same regardless of the phase shift quantity; however, the magnitude itself of each peak varies with the phase shift quantity.

[a3] Coupling Light Relatively Great in Intensity to Two Out of the Output Waveguides 19a to 19d and Coupling Light Relatively Small in Intensity to the Other Two Output Waveguides

In the optical circuit 10 according to the first embodiment, the delay waveguide 12 is adapted to provide a delay distance shorter by λ/4 than one symbol distance by delay adjustment. The adjustment of such a delay distance enables light to be made relatively great in intensity for two out of the four outputs from output waveguides 19a to 19d, and enables light to be made relatively small in intensity for the other two outputs.

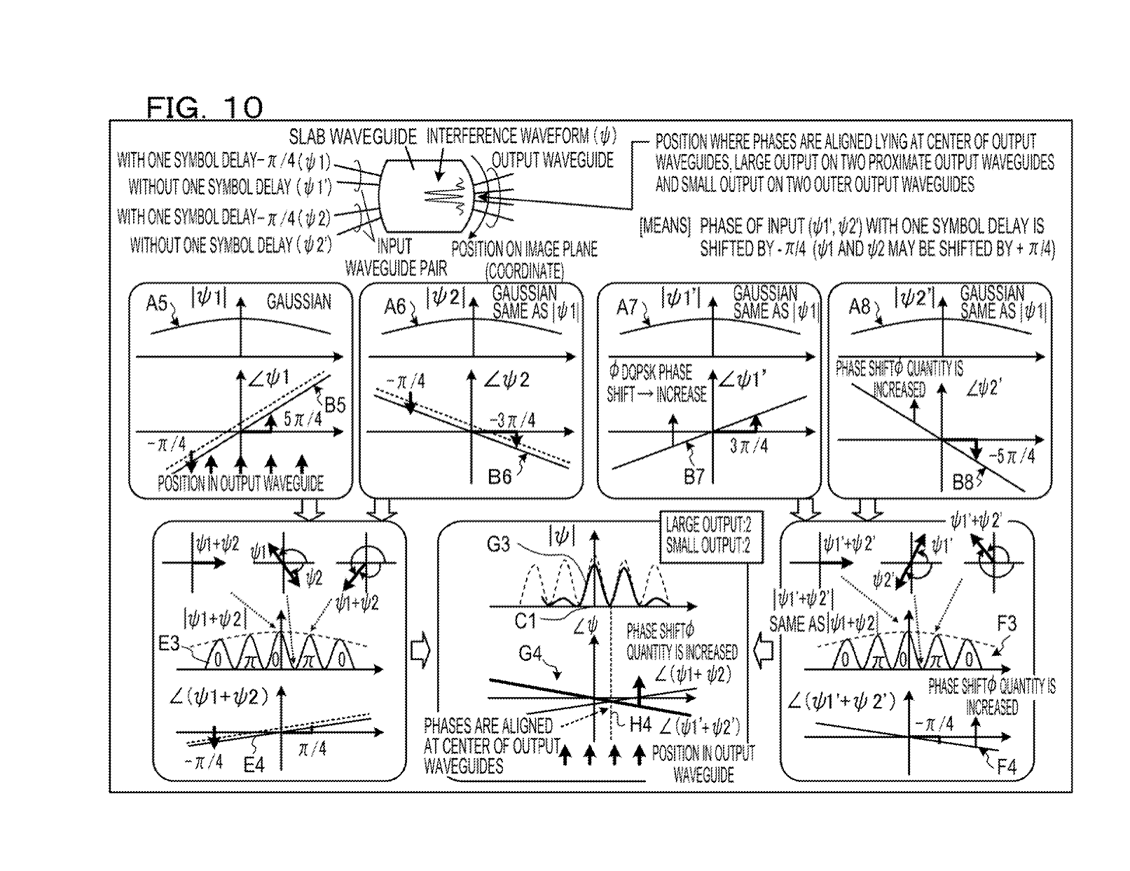

FIG. 10 describes how an output intensity distribution is obtained by the above delay adjustment. Although FIG. 10 also particularly focuses on the case where a phase shift quantity φ related to the differential phase shift keying between symbols is zero, even if the phase shift quantity φ is not zero, how an output intensity distribution is obtained is described in a similar manner in FIG. 10.

Also in the case where the delay waveguide 12 is adapted to provide a delay distance shorter by λ/4 than one symbol distance by delay adjustment, the electric field intensity distributions in positions on the image plane in ψ1, ψ1′, ψ2, and ψ2′ represented by the Equation (1) (respective absolute values) form substantially the same Gaussian distribution with peaks at the center point C1 (refer to FIG. 7) at the end 18b as indicated by A5 to A8 of FIG. 10. This point is the same as in FIG. 9.

As for phase distribution in position on the image plane, for ψ1′ and ψ2′ that are not delayed in the delay waveguide 12, B7 and B8 illustrated in FIG. 10 are the same as B3 and B4 illustrated in FIG. 9. However, for ψ1 and ψ2, a segment forming a slope characteristic corresponding to a delay adjustment of −π/4 descends as indicated by B5 and B6.

The vector addition of ψ1 and ψ2 on the phase plane corresponding to a position on the image plane in accordance with the Equation (1) about ψ provides E3 in FIG. 10 in respect to the electric field intensity distribution of ψ1+ψ2, and the electric field intensity distribution itself is the same as in FIG. 9 without a delay adjustment quantity (refer to E1 in FIG. 9). On the other hand, as indicated by E4, a phase distribution of (∠ψ1+ψ2) has a phase quantity of zero at a point where the phase distribution moves from the center point C1 toward the output waveguide 19d by π/4 corresponding to the fluctuation portion of the segment indicated by B5 and B6, and the phase quantity increases (by π/4 between the adjacent output waveguides) according to positions corresponding to the positions from the output waveguide 19a to the output waveguide 19d.

The vector addition of ψ1′ and ψ2′ on the phase plane corresponding to positions on the image plane provides F3 and F4 illustrated in FIG. 10 respectively in respect to the electric field intensity distribution and the phase distribution of ψ1′+ψ2′ which are the same as F1 and F2 in FIG. 9.

Adding (ψ1+ψ2) to (ψ1′+ψ2′) with such electric field intensity distribution and phase distribution in accordance with the Equation (1) provides G3 in respect to the electric field intensity distribution of ψ. In other words, the phases of (ψ1+ψ2) and (ψ1′+ψ2′) are aligned at the position H4 where the phase distributions E4 and F4 intersect each other.

If a delay adjustment quantity is not provided, the phases are aligned at the center point C1, as illustrated in FIG. 9, so that the peaks of the electric field intensities E1 and F1 reinforce each other to form a distribution with a peak at the center point C1. On the other hand, if a delay adjustment quantity (−π/4) is provided, the phases are aligned in a position G14 shifted from the center point C1 as indicated by G4 of FIG. 10. Since the electric field intensities E3 and F3 of (ψ1+ψ2) and (ψ1′+ψ2′) are zero in the position, the electric field intensities in added ψ are also zero.

As indicated by G3, the electric field intensity distribution G3 is comparatively large in output at a position corresponding to the peak of intensity of (ψ1+ψ2) and (ψ1′+ψ2′) and being closest to the position H4 where the phases are aligned and can be made comparatively small in a position corresponding to the peak of intensity on the outside. In other words, four output waveguides 19a to 19d are formed in positions corresponding to two peaks at the left and the right of the position H4 respectively to increase the difference between the small and the large level of light input to the balanced receiver 4c (refer to FIG. 1) provided at the rear stage, improving accuracy in balanced reception.

If a phase shift quantity φ is greater than zero, also the position where phases are aligned moves according to the phase shift quantity. For this reason, positions themselves on the image plane where an electric field intensity distribution reaches a peak are the same without regard to the phase shift quantity, however, the magnitude itself of each peak varies with the phase shift quantity.

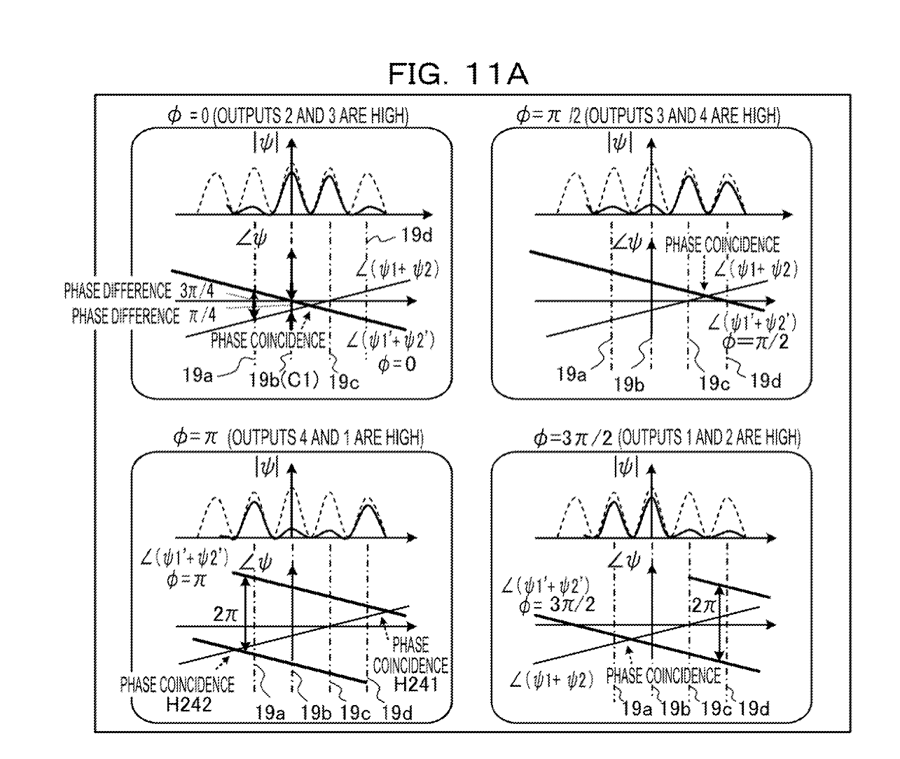

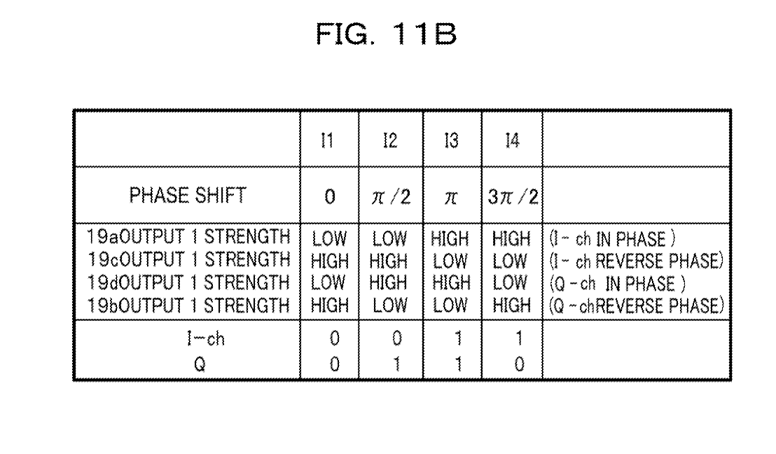

FIG. 11 is a chart illustrating the electric field intensity distribution and phase quantity distribution of the interference waveform ψ according to phase shift quantity along with positions where the output waveguides 19a to 19d are formed.

In the case of a phase shift quantity φ=0, an electric field intensity distribution is G3 illustrated in FIG. 11A. The position H4 where the phases of (ψ1+ψ2) and (ψ1′+ψ2′) coincide with each other is shifted from the center point C1 corresponding to a position where the output waveguide 19b is formed and lies between positions where the two central output waveguides 19b and 19c are formed. In this case, interference lights comparatively great in intensity are coupled together in the output waveguides 19b and 19c, and on the other hand, interference lights comparatively small in intensity are coupled together in the output waveguides 19a and 19d (refer to FIG. 10).

Thus, as illustrated by I1 of FIG. 11B, in the light input to the balanced receiver 4c provided at the rear stage, the in-phase of the channel I from the output waveguide 19a can be made to be low, the reverse phase of the channel I from the output waveguide 19c can be made to be high, the in-phase of the channel Q from the output waveguide 19d can be made to be low, and the reverse phase of the channel Q from the output waveguide 19b can be made to be high. Thus, the difference between the low and the high level inputs to phases of the channels I and Q can be increased.

In the case of a phase shift quantity φ=π/2, an electric field intensity distribution is represented by G13. A position H14 where the phases coincide with each other lies between positions where the two output waveguides 19c and 19d are formed. In this case, interference lights comparatively great in intensity are coupled together in the output waveguides 19c and 19d, and on the other hand, interference lights comparatively small in intensity are coupled together in the output waveguides 19a and 19b. Thus, the difference between the small and the large level input to phases of the channels I and Q can be increased, as illustrated by I2 of FIG. 11B.

In the case of a phase shift quantity φ=π, an electric field intensity distribution is represented by G23. The phases coincide with each other in an outer position H241 where the output waveguide 19a is formed and an outer position H242 where the output waveguide 19d is formed. In this case, interference lights comparatively great in intensity are coupled together in the output waveguides 19a and 19d and, on the other hand, interference lights comparatively small in intensity are coupled together in the output waveguides 19b and 19c. In this case also, the difference between the small and the large levels input to phases of the channels I and Q can be increased, as illustrated by I3 of FIG. 11B.

In the case of a phase shift quantity φ=3π/2, an electric field intensity distribution is represented by G33. A position H34 where the phases coincide with each other lies between positions where the two output waveguides 19a and 19b are formed. In this case, interference lights comparatively great in intensity are coupled together in the output waveguides 19a and 19b, and on the other hand, interference lights comparatively small in intensity are coupled together in the output waveguides 19c and 19d. In this case also, the difference between the small and the large level inputs to phases of the channels I and Q can be increased, as illustrated by I4 of FIG. 11B.

In the optical circuit 10 of the first embodiment, the delay waveguide 12 provides the above delay adjustment quantity. According to the present embodiment, however, the two outputs of the second branch unit 13 may be provided with a delay adjustment quantity of +44.

[a4] Operational Advantage

The optical circuit 10 of the first embodiment configured as described above can be applied to the demodulator 4b of the reception apparatus 4 in the optical communication system 1 illustrated in FIG. 1. In this case, the DQPSK modulated light input from the wavelength demultiplexer 4a is subjected to delay and interference to output an intensity modulation light (On-Off keying: OOK) according to a phase shift quantity with respect to an optical phase of one symbol before in the form of the in-phase and the reverse phase output of the channel I and the in-phase and the reverse phase output of the channel Q.

Thereby, the balanced receiver 4c balanced-receives the lights of the channels I and Q to enable data demodulation processing by electrical signal processing at the rear stage.

As described above, the output waveguides 19a to 19d forming the demodulator 4b in the optical circuit 10 are formed at the end 18b of the slab waveguide 18 and in positions where the intensities of lights separated by interference into a plurality of beams reach peaks. This allows improving an optical coupling efficiency from the slab waveguide 18 to the output waveguides 19a to 19d. Since optical power in positions on the image plane that is not coupled to the output waveguide 19a to 19d can be placed in the valley of an electric field intensity distribution, the amount of stray light can be decreased.

FIG. 12 illustrates an optical circuit 100 as a DQPSK demodulator as an example of comparison configuration to describe operational advantages of improving an optical coupling efficiency and decreasing stray light in the optical circuit 10 of the first embodiment. The optical circuit 100 illustrated in FIG. 12 includes a delay branch circuit 101 and an interference waveguide unit 102 and substantially corresponds to a demodulator described in the Non-Patent Document 1.

The delay branch circuit 101 includes a 3 dB coupler 101a for branching, for example, an input DQPSK modulated light into two lights and includes a delay difference generating unit 101b for providing two lights branched by the 3 dB coupler 101a with a difference in delay time corresponding to one symbol time period. The interference waveguide unit 102 includes a pair of input waveguides 103a and 103b for correspondingly introducing two lights which are formed by the delay difference generating unit 101b and having a difference in delay time corresponding to one symbol time period, and further includes a slab waveguide 104 and four output waveguides 105a to 105d which are the same as those illustrated in FIG. 5.

For this reason, the delay branch circuit 101 of the optical circuit 100 is different from the delay branch circuits (reference numerals 11 to 15) of the optical circuit 10 according to the first embodiment and outputs a pair of two phase modulated lights having a difference in delay time corresponding to one symbol time period instead of two pairs thereof. The input waveguides 103a and 103b with a distance d therebetween in the interference waveguide unit 102 are taken as a pair.

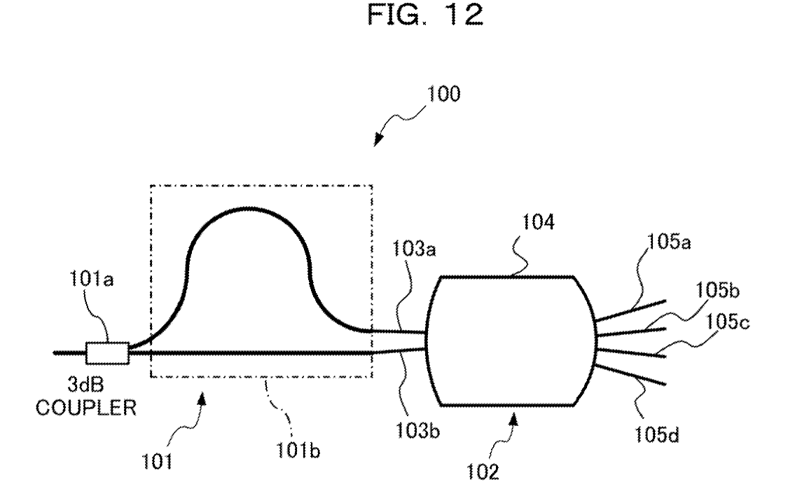

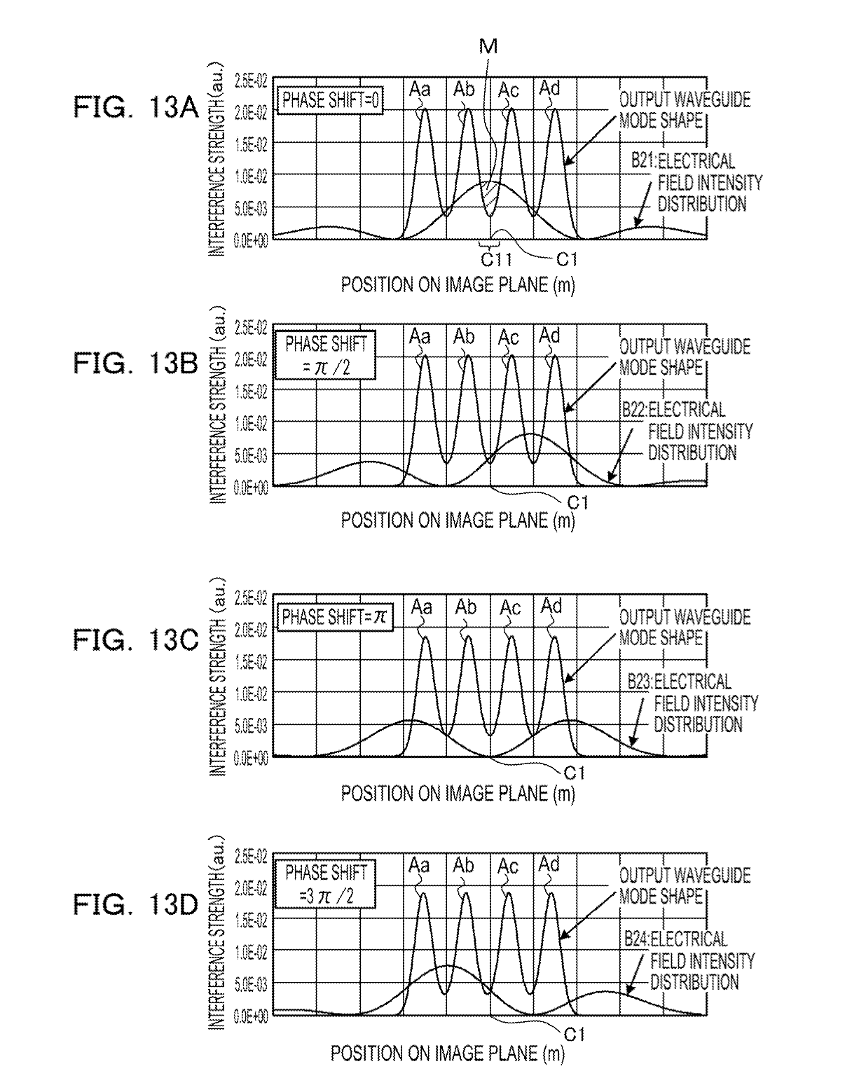

In the optical circuit 100 thus configured, lights from two input waveguides 103a and 103b interfere with each other in the slab waveguide 104 and are imaged at the other end thereof where the output waveguides 105a to 105d are formed. At this point, in the case where the phase shift quantities for DQPSK modulation are taken as 0, π/2, π, and 3π/2, the electric field intensity distributions of interference lights are expressed by B21 to B24 in FIGS. 13A to 13D with positions on the image plane of the slab waveguide 104 as abscissa.

In FIGS. 13A to 13D, Aa to Ad illustrate examples of mode shapes of light optically coupled to the output waveguides 105a to 105d. If the optical circuit 100 is used as a demodulator for DQPSK modulated light, two-bit modulated information is detected with a high sensitivity by a light receiving element as a light intensity of the interference light, so that four interference-light outputs are obtained.

However, the electric field intensity distribution of the interference light illustrated in FIGS. 13A to 13D has Gaussian distribution in which the electric field intensity distribution is more widely dispersed than that in FIGS. 8A to 8D. That is to say, even if the output waveguides 105a to 105d are arranged in an area around the center of the image plane at which the electric field intensity distribution of the interference light converges without regard to the phase shift quantity between symbols in modulated light, sufficiently intense and optically coupled interference light cannot be obtained.

In other words, the interference light optically coupled to the output waveguides 105a to 105d has falling intensity within the mode shapes Aa to Ad of the output waveguides 105a to 105d among the electric field intensity distributions B21 to B24 of the interference light. For this reason, particularly, like light imaged within the image plane position range C11 in FIG. 13A, the quantity of stray light M increases in which light having a certain degree of electric field intensity and coupled to the output waveguides 105a to 105d is clipped off. Thus, in the configuration illustrated in FIG. 12, there are comparatively few components of the electric field intensity distribution of the interference light matching the mode shapes of the output waveguides 105a to 105d, which poses an obstacle in improving optical coupling efficiency.

On the other hand, the optical circuit 10 of the first embodiment illustrated in FIG. 7 is provided with the two waveguide pairs 17A and 17B each having two input waveguides in a straight orbit from the center point C1 at the end 18b of the slab waveguide 18 as the input waveguides for introducing light subjected to interference. The distance between the waveguide pairs 17A and 17B is set to be substantially four times as great as the distance between the input waveguides of each pair to enable dividing the peaks of the interference light into four corresponding to the output waveguides 19a to 19d, so that the coupling efficiency of the interference light to the output waveguide 19a to 19d and the suppression effect of stray light can be substantially improved in comparison to the configuration of FIG. 12.

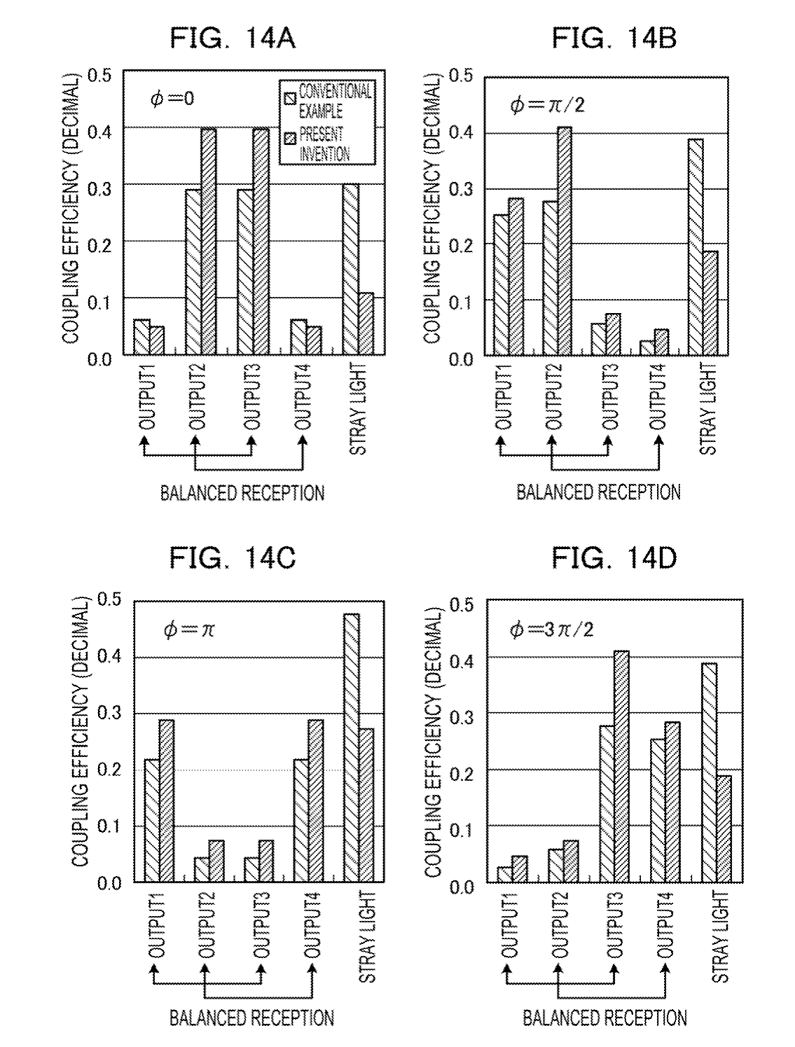

FIG. 14 is a chart for comparing the coupling efficiency to the output waveguide and the magnitude of stray light according to the phase shift quantity φ of the input differential phase modulated light in the case of the optical circuit 10 of the first embodiment (heavily shaded bar graph) and the comparison configuration illustrated in FIG. 12 (lightly shaded bar graph). FIGS. 14A, 14B, 14C, and 14D illustrate comparison results at phase shift quantities φ=0, φ=π2, φ=π, and φ=3π/2 respectively.

As illustrated in FIGS. 14A to 14D, the coupling efficiency of the interference light to the output waveguides 19a to 19d in the first embodiment has a better characteristic than the coupling efficiency of the interference light to the output waveguides 105a to 105d in the comparison configuration, and the amount of stray light to be generated without regard to the phase shift quantity φ can be suppressed.

Thus, according to the first embodiment, there can be provided the optical circuit which improves the reception sensitivity of phase modulated light.

### [b] Description of the Second Embodiment

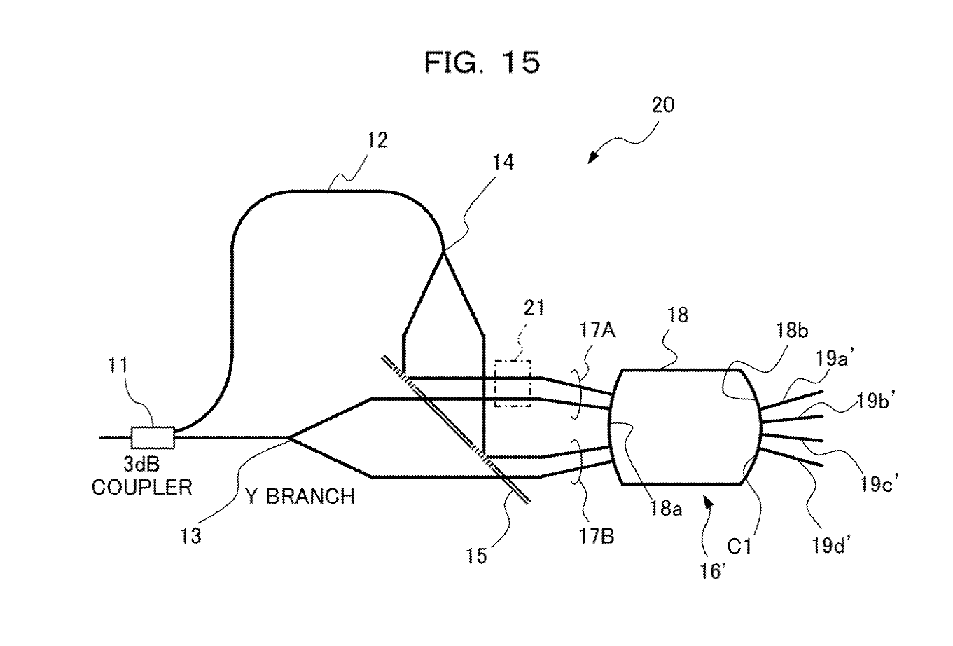

FIG. 15 is a schematic diagram of an optical circuit 20 according to a second embodiment. The optical circuit 20 illustrated in FIG. 15 is different from the optical circuit 10 in the first embodiment in the configuration of the delay branch circuit in that the optical circuit 20 is provided with a π delay unit 21 for further delaying two lights introduced to the waveguide pair 17A out of the waveguide pairs 17A and 17B by a delay quantity corresponding to substantially ½ of the optical wavelength, and output waveguides 19a′ to 19d′ forming an interference waveguide unit 16′ are differently arranged, however, other configurations other than those described above are basically the same as in the optical circuit 10 of the first embodiment. In FIG. 15, the same reference numerals and characters in FIG. 5 denote substantially the same parts.

The π delay unit 21 is a second delay unit for further delaying one pair of two phase modulated light pairs branched by a second and a third branch unit 13 and 14 and introduced to the waveguide pairs 17A and 17B respectively by a delay quantity corresponding to substantially ½ of the optical wavelength with respect to the other pair of the phase modulated light pairs. The optical delay of the π delay unit 21 delays the arrangement of peaks forming the intensity distribution of light imaged at the end 18b of the slab waveguide 18.

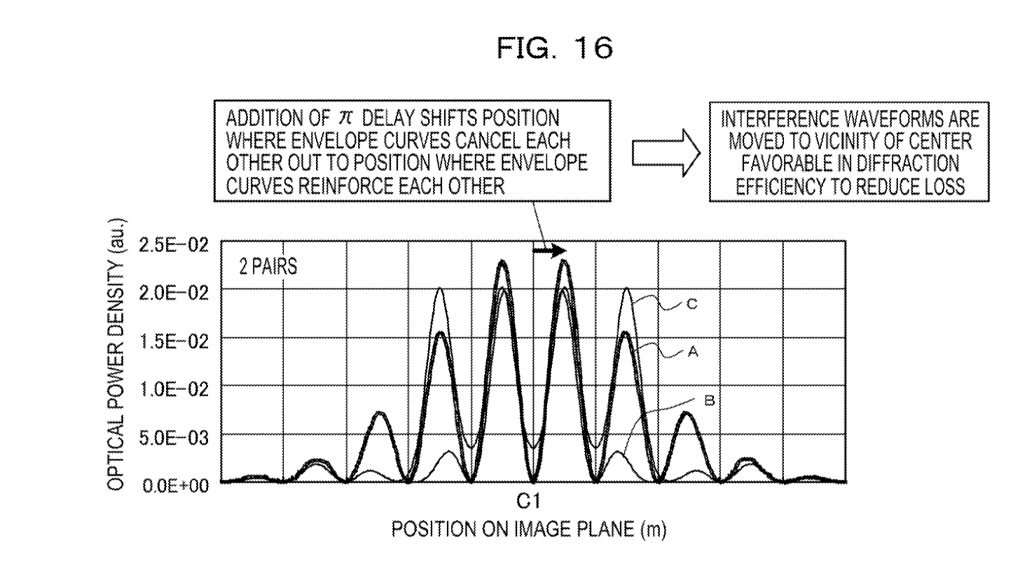

In the optical circuit of the first embodiment, as illustrated in FIGS. 8A to 8D, one of the peak distributions B2 in positions on the image plane substantially coincides with the center point C1 in positions on the image plane. On the other hand, in the optical circuit 20 of the second embodiment, as illustrated by A or B in FIG. 16, the delay processing of the π delay unit 21 moves the interference waveforms to the vicinity of the center of the end 18b favorable in diffraction efficiency to reduce loss.

The peak distribution in positions on the image plane can be shifted from the center point C1 and four peak distributions can be arranged in a position substantially symmetrical to the center point C1 and the output waveguides 19a′ to 19d′ can be formed to be substantially symmetrical to the center point C1. Reference character C in FIG. 16 denotes the mode shape of the output waveguides 19a′ to 19d′ thus formed.

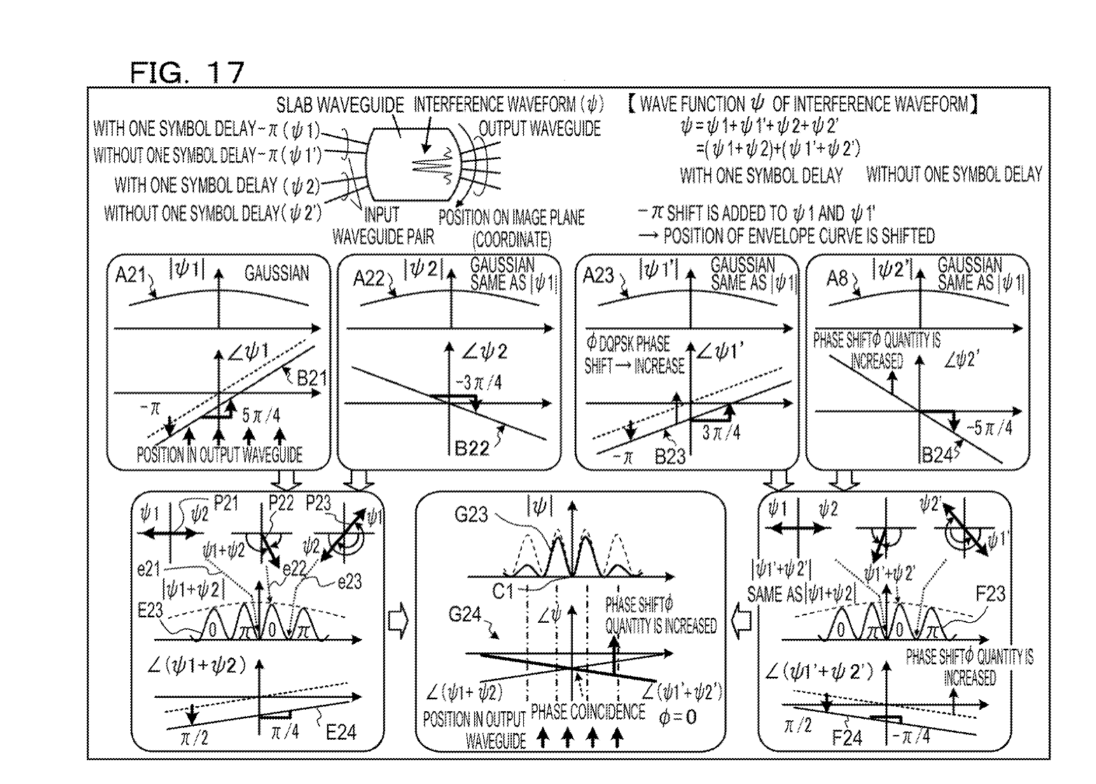

FIG. 17 is a chart describing how the adjustment of quantity of delay provides an output intensity distribution. Although FIG. 17 particularly focuses on a case where a phase shift quantity φ related to the differential phase shift keying between symbols is zero, even if the phase shift quantity φ is not zero, how the adjustment of quantity of delay provides an output intensity distribution can be described in the same manner in FIG. 17.

Even if the π delay unit 21 provides light introduced to the waveguide pair 17A with a delay quantity (π) corresponding to ½ of the optical wavelength, the electric field intensity distributions (respective absolute values) in positions on the image plane in ψ1, ψ1′, ψ2, and ψ2′ represented by the Equation (1) form substantially the same Gaussian distribution with peaks at the center point C1 (refer to FIG. 7) at the end 18b as illustrated by A21 to A24 in FIG. 17. This point is the same as the case in FIG. 9.

As for phase distribution in position on the image plane, in ψ2 and ψ2′, which are not delayed in the π delay unit 21, B22 and B24 illustrated in FIG. 17 are the same as B2 and B4 illustrated in FIG. 9. However, as for ψ1 and ψ1′, as indicated by B21 and B23, a segment forming a slope characteristic corresponding to a delay adjustment of −π descends. In other words, phase quantities of ψ1 and ψ1′ are −π at the center point C1.

The vector addition of ψ1 and ψ2 on the phase plane corresponding to a position on the image plane in accordance with the Equation (1) about ψ symmetrically arranges two peaks on both sides of the center point C1 in respect to the electric field intensity distribution of ψ1+ψ2 as indicated by E23 in FIG. 17. On the other hand, as for a phase distribution of (∠ψ1+ψ2), as indicated by E24, the phase quantity is changed from zero at the center point C1 to −π/2 corresponding to the fluctuation portion of the segment indicated by the B21 and increases according to positions corresponding to positions from the output waveguide 19a to the output waveguide 19d (the phase quantity increases by π/4 between the adjustment output waveguides).

That is to say, the phase quantity of ψ1 is zero and that of ψ2 is −π at an image-plane position e21 corresponding to the center point C1. Both have phase vectors in directions opposite to each other (P21). For this reason, ψ1 and ψ2 cancel each other out in the image-plane position e21 to substantially minimize (zero) the electric field intensity. On the other hand, ψ1 and ψ2 are in phase (P22) in an image-plane position e22 in FIG. 17. Both light waves are emphasized to create a peak of the optical intensity. In an image-plane position e13, ψ1 and ψ2 are out of phase with each other substantially by π (P23). Both light waves are weakened to substantially minimize (zero) the optical intensity.

The vector addition of ψ1′ and ψ2′ on the phase plane corresponding to positions on the image plane provides F23 and F24 illustrated in FIG. 17 in respect to the electric field intensity distribution and the phase distribution of ψ1′+ψ2′. That is to say, as for the electric field intensity distribution, as is the case with the ψ1+ψ2, two peaks are symmetrically arranged on both sides with respect to the center point C1.

On the other hand, as for the phase distribution (∠ψ1+ψ2), as indicated by F24, the phase quantity is changed from zero at the center point C1 to −π/2 corresponding to the fluctuation portion of the segment indicated by the B23 and decreases according to positions corresponding to the positions from the output waveguide 19a to the output waveguide 19d (the phase quantity decreases by π/4 between the adjustment output waveguides).

Adding (ψ1+ψ2) to (ψ1′+ψ2′) having the electric field intensity distribution and the phase quantity distribution in accordance with the above Equation (1) produces G23 in respect to the electric field intensity distribution of ψ. The phases of (ψ1+ψ2) and (ψ1′+ψ2′) are aligned at the position corresponding to the center point C1, where the phase distributions E24 and F24 intersect each other. At this point, the electric field intensity distribution of ψ, as indicated by G23, becomes minimal (zero) in the position corresponding to the center point C1 and two peaks of the electric field intensity distribution are symmetrically arranged on both sides with respect to the center point C1.

Thus, the second embodiment has the advantage that the delay processing of the π delay unit 21 moves the interference waveforms to the vicinity of the center of the end 18b favorable in diffraction efficiency to reduce loss.

Furthermore, the peak distribution in positions on the image plane can be shifted from the center point C1 and four peak distributions can be arranged in a position substantially symmetrical to the center point C1 and the output waveguides 19a′ to 19d′ can be formed to be symmetrical to the center point C1, facilitating the design of the interference waveguide unit 16′.

Embodiments of the disclosure and the advantages thereof are described above. Those skilled in the art may make various modifications, additions, and omissions without departing from the spirit and scope of the present invention clearly described in claims.

What is claimed is:

1. An optical circuit comprising:
at least two pairs of two input waveguides;
a slab waveguide one end of which is coupled to two pairs or more of the two input waveguides; and
four output waveguides coupled to another end of the slab waveguide; wherein
a distance between two pairs of adjacent two input waveguides among two pairs or more of the two input waveguides is approximately four times as long as a distance between the two input waveguides.

2. The optical circuit according to claim 1, wherein
each pair of the two input waveguides introduces, as phase modulated lights, two lights corresponding to approximately one symbol in the phase modulation and having a delay difference being an integral multiple of an optical wavelength, and the four output waveguides output light in which the lights introduced from two pairs of the two input waveguides are subjected to interference by the slab waveguide as a intensity modulated light according to the phase modulation.

3. The optical circuit according to claim 2, wherein
each pair of the two input waveguides is configured to introduce the two lights subjected to a delay quantity adjustment by which the delay difference is further increased or decreased by ¼ of an optical wavelength.

4. The optical circuit according to claim 2, wherein
the two introduced lights subjected to a delay quantity adjustment are introduced to one of the two pairs of the two input waveguides, the delay quantity adjustment further delaying the lights by approximately ½ of the optical wavelength with respect to the lights introduced to the other of the two pairs of the two input waveguides.

5. The optical circuit according to claim 2, further comprising a delay branch circuit for forming two pairs of phase modulated lights from the input phase modulated lights with two lights as one pair having a delay difference corresponding to one symbol in the phase modulation, and for outputting two lights to introduce to each pair of the two input waveguides.

6. The optical circuit according to claim 5, wherein
the delay branch circuit subjects the two pairs of phase modulated lights to a delay quantity adjustment by which the delay difference is increased or decreased by ¼ of the optical wavelength.

7. The optical circuit according to claim 5, wherein
the delay branch circuit is configured to perform a delay quantity adjustment by which one of the two pairs of the phase modulated lights is delayed by approximately ½ of the optical wavelength with respect to the other of the two pairs of the phase modulated lights.

8. The optical circuit according to claim 5, wherein the delay branch circuit comprises:
a first branch unit for branching an input phase-modulated light into two lights;
a first delay unit for delaying one of the lights branched by the first branch unit by one symbol with respect to the other light;
a second branch unit for further branching the other light branched by the first branch unit into two lights; and
a third branch unit for further branching the light delayed by the first delay unit into two lights; wherein one of the lights branched by the second branch unit and one of the lights branched by the third branch unit are taken as one pair of the phase modulated lights, the other light branched by the second branch unit and the other light branched by the third branch unit are taken as the other pair of the phase modulated lights, and the one and the other pair of the phase modulated lights are output to corresponding input waveguide pairs.

9. The optical circuit according to claim 8, wherein the first delay unit subjects one of the lights branched by the first branch unit to a delay quantity adjustment by which the delay difference is made greater or smaller by ¼ of the optical wavelength than the one symbol portion.

10. The optical circuit according to claim 8, further comprising a second delay unit for performing a delay quantity adjustment by which one of the two pairs of the phase modulated lights is delayed by approximately ½ of the optical wavelength with respect to the other of the two pairs of the phase modulated lights.

11. The optical circuit according to claim 2, wherein
the input phase modulated light is a differential quadrature phase-shift keying light and the four output waveguides differentially output two-bit signals related to the differential quadrature phase-shift keying.

12. The optical circuit according to claim 11, wherein
light comparatively great in intensity is coupled to two of the four output waveguides and light comparatively small in intensity is coupled to two other output waveguides.

13. The optical circuit according to claim 11, wherein an adjacent distance “a” between the four output waveguides is substantially set by the following equation:
a=(λ/4)·f/d
where, “f” is a slab length of the slab waveguide, “λ” is the optical wavelength, and “d” is a distance between the two input waveguides forming each pair.

14. The optical circuit according to claim 1, wherein the four output waveguides are coupled to positions substantially matched to the optical intensity peaks imaged by optical interference from the two pairs of two input waveguides in the slab waveguide.
